(19) United States
(12) Patent Application Publication
(10) Pub. No.: US 2007/0023200 A1
(43) Pub. Date: Feb. 1, 2007

(54) Cable splice closure and method of installation therefor

(76) Inventors: Maarten Michiels, Huldenberg (BE); Gwen Fouquet, Tielt Winge (BE)

Correspondence Address: BAKER & DANIELS LLP, 300 NORTH MERIDIAN STREET, SUITE 2700, INDIANAPOLIS, IN, 46204, US

(21) Appl. No.: 10/563,408

(22) PCT Filed: Jun. 29, 2004
(86) PCT No.: PCT/GB04/02825

§ 371 Date: Jan. 4, 2006

(30) Foreign Application Priority Data
Jul. 8, 2003 (GB) 0315948.0

(51) Int. Cl. H02G 15/08

(52) U.S. Cl. 174/93

(57) ABSTRACT

A cable splice closure comprising a casing and at least one resilient end plug for closing a respective entry/exit port of the casing, the casing being capable of being closed around the said plug to close the closure, the said end plug having at least one opening through which a length of cable or other elongate member is capable of being fed into the interior of the closure, and at least one retention means for retaining the said cable or other elongate member with respect to the plug, the plug being compressed, in use, by closure of the casing such that the said cable or elongate member is held with respect to the plug by compression forces applied to the plug by the said casing.

This invention relates to a cable splice closure, a method of installing the cable splice closure and a kit of parts for providing a cable splice closure.

Many different types of cable splice closure are known. For example, International Patent Application No. PCT/GB96/00194 discloses a telecommunications cable splice closure comprising a pair of semi-cylindrical elongate casing parts which can be brought together around a cable splice to close the closure with the cable splice located in the interior of the closure. The closure includes a pair of cable retention grippers which can be operated, that is to say tightened against the surface of the cable, from the exterior of the casing parts.

To enclose a cable splice, strips of sealing material, which may be mastic or gel for example, are wrapped around the cables on opposite sides of the splice. Each gripper is located adjacent to a respective seal on the opposite side of the seal to the cable splice. The jaws of the cable gripper are tightened around the cable by tightening one or more screw-threaded bolts or other fastening means extending out of the casing. The cable grippers are located in the respective slots and the casing parts are brought together along their opposing longitudinal edges and secured together by threaded fasteners along the longitudinal edges of the casing parts. This arrangement allows the closure to be closed around a cable splice before it is tightly secured to the cables, thus permitting adjustments to the position of the closure with respect to the cables after it has been closed around the splice, that is to say the position of the cable splice can be adjusted within the closed enclosure before the cables that are fed into the closure are secured by tightening the jaws of the cable grippers around the exterior surface of the respective cables.

The closure described in PCT/GB96/0194 is quite complex in construction, containing a large number of parts which have to be assembled together by the installation engineer in order to secure the splice cables to the closure and ensure that the closure is correctly sealed. In particular the installation engineer has to ensure that sufficient sealing material is wrapped around the cables so that it is capable of forming an effective environmental seal when the casing is closed. This requires the installation engineer to use “measuring strips” or the like which are used as aid by the installation engineer during the installation process. Measuring strips are also required when axial pull-out strips are used instead of the aforementioned grippers. Pull-out strips are used to grip the cable around which they are wrapped and provide a means by which axial pull-out loads may be transferred to the casing of the closure.

There is a requirement therefore to provide an improved cable splice closure which is easy to install around a cable splice, which is simple in construction, and which has only a small number of components while ensuring it is inexpensive to manufacture, which provides good environmental sealing, and which substantially prevents forces, particularly axial and bending forces which may act on the cables in use, from damaging a splice enclosed by the closure.

There is a further requirement to provide an improved cable splice closure which is easy to install and to re-enter. There is a further requirement for a cable splice closure which overcomes the requirement for axial pullout strips to be wrapped around the cable during installation, and the use of measuring strips during the installation process.

According to an aspect of the invention there is provided a cable splice closure comprising a casing and at least one resilient end plug for closing a respective entry/exit port of the casing, the casing being capable of being closed around the said plug to close the closure, the said end plug having at least one opening through which a length of cable or other elongate member is capable of being fed into the interior of the closure, and at least one retention means for retaining the said cable or other elongate member with respect to the plug, the plug being compressed, in use, by closure of the casing such that the said cable or elongate member is held with respect to the plug by compression forces applied to the plug by the said casing.

In the present invention the cable or cables fed into the interior of the closure are retained by the retention means which resist axial tensile forces, acting to pull the cables out of the closure, torsion, and bending of the cables. Retention of the cables is achieved by the retention means and additionally or alternatively by compression of the plug by the casing when the casing is closed to close the closure.

Preferably, the said cable retention means is capable of being wrapped around the exterior of the plug to surround the plug and the said cable so that tightening of the retention means draws the said cable and plug together and compresses the plug against the cable. In this way it is possible for the cable or cables to be inserted in the respective openings of the plug prior to the retention means being wrapped around the exterior of the plug. In this way it is also possible to correctly position the cables to be retained by the plug before the retention means are wrapped around the exterior of a plug. Preferably, the retention means comprises a cable tie or “wrap tie”. Cable or wrap ties are well known and include, for example, elongate tooth belts having a buckle or eyelet at one end through which the other end of the tie is threaded to form a loop which may be tightened around an object encircled by the tie. Typically the jaws of the buckle prevent the tie from opening such that when it is tightened, in this case around the plug and cable or cables, it can only be removed by cutting. Cable tie or wrap tie type tensioning means are particularly suitable for use in embodiments of the present invention since they permit the cable or cables to be readily and reliably fixed to the plug.

The cable ties readily enable the installation engineer to apply sufficient pressure to the cable or cables against the resilience of the plug to provide sufficient frictional resistance between the cable or cables and the plug to prevent axial pullout of the cable or cables from the closure.

In preferred embodiments, the plug is generally cylindrical and preferably has a generally circular cross-section in the plane normal to the longitudinal direction of the cylinder. The shape and size of the plug is generally determined by the shape and size of the entry/exit port of the closure casing in which it is to be fitted and therefore different shaped plugs are contemplated by the present invention.

Preferably the opening extends in the longitudinal direction of the plug to provide at least one open channel on the exterior of the plug for receiving the cable. The plug thus receives a length of at least one cable which is gripped along its length by compression of the plug by the casing in use. Generally, the greater the length of cable that is gripped by compression of the plug the greater the frictional forces acting on the cable to resist axial pullout.

In preferred embodiments the plug comprises a plurality of channels circumferentially spaced about the exterior of the plug. This readily enables a plurality of cables to be fed into the interior of the closure through the channels in the exterior of the plug. The present invention contemplates installations where not all of the channels are used for feeding a respective cable into the interior of the closure, for example there may be installations where only three of say four channels are required for cables. In order to ensure the correct functioning of the cable splice closure when not all the channels are used for cable, blanking rods having a shape and size corresponding to the shape and size of the empty channel, or cable, can be inserted in that channel to ensure that the correct amount of compression is applied to the resilient plug when the casing is closed around the plug. In other embodiments one or more channels may be utilised to convey a tube or the like for an air pressurisation valve, for example, for active pressurisation of the closed enclosure for effective sealing thereof.

The present invention also contemplates embodiments where different channels are sized to accommodate different size cables, that is to say different diameter cables. A typical range of cable sizes may be between 3 mm and 6.7 mm diameter and in the case of larger diameter cables, for example 6.7 mm diameter, the cables may be retained wholly with respect to the plug by compression of the plug by closing the casing around the plug, that is independently of cable or wrap ties holding the cable against the plug. The ability to accommodate different size cables is particularly important in installations which may be reconfigured from time to time, for example in a telecommunications network where it may be desirable or necessary to replace existing cables with different size cables during reconfiguration.

Preferably, the plug comprises at least one circumferential cable retention groove for receiving a length or lengths of cable deflected radially inwards into the grooves, in use, by tightening of a respective cable retention means surrounding the exterior of the plug and the cable in the region of the groove. The cable retention groove readily enables the length of cable passing over the groove to be pulled into that groove and retained therein by tightening a cable or wrap tie around the cable or cables positioned at the groove.

It is preferable that the radial depth of the cable retention groove is greater than the radial depth of the longitudinal channel carrying the cable so that the length of cable passing over the groove can be bent, effectively drawn, into the groove by the action of tightening the cable wrap ties. This preferably results in a U-shaped length of cable in the groove between opposing sections of the channel on either side of the groove.

It is preferable that the depth of the cable retention groove in the radial direction of the plug is sufficient to accommodate not only the deflected cable but also the cable retention means acting on the cable around the groove. In this way the cable retention means, that is the cable wrap tie, is substantially enclosed within the groove so that it does not interfere with the compression of the resilient plug when compressed by the casing on closure of the casing around the plug. In embodiments where the depth of the groove is greater than the radial depth of the retention of the channels retention means (cable wrap tie) in the groove is substantially improved since the groove substantially eliminates sliding of cable wrap tie over the exterior of the plug, even when the plug is compressed, since the diameter of the tightened cable wrap tie is less than the compressed diameter of the plug.

In preferred embodiments the plug comprises at least two circumferential grooves spaced apart along the length of the plug. Each groove is provided for accommodating a respective retention means (cable wrap tie) so that in preferred embodiments of the invention at least two cable wrap ties are used to secure the cable or cables along their length. This obviously increases the axial pull-out resistance of the cables from the closure. In preferred embodiments a pair of the cable retention grooves are positioned at opposite axial ends of the plug, that is to say at a closure exterior end of the plug and at the closure interior end of the plug.

The closure of the present invention preferably comprises at least one further circumferential groove having a compressible seal located therein for compression of the seal against the plug and the cable to hold the seal against the plug and the cable so as to seal the closure and further retain the cable with respect to the closure by force(s) applied by the casing to the seal and the plug when the casing is closed. When the casing is closed the seal is compressed thus sealing around the cable or cables and sealing between the cable or cables and the casing.

In preferred embodiments, the further groove containing the seal is axially located between first and second cable retention grooves at respective opposite ends of the plug. Preferably, the further groove for the seal is located in the centre of the plug.

In preferred embodiments the further groove has a depth in the radial direction greater than the radial depth of the cable retention grooves. The size and shape of the further groove for the seal is determined by the size and shape of the seal that is to be located within it. In preferred embodiments the seal comprises a gel type material shaped as torus that can be fitted over the exterior of the plug and located in the region of the further groove in the centre of the plug so that it can be compressed to seal around the cables and between the cables and the casing of the closure. The toroidal seal is shaped and sized to ensure that an effective environmental seal is formed when the casing is closed around the plug thereby eliminating the possibility of poor quality sealing due to insufficient sealing tape being wrapped around the cables as in the aforementioned earlier methods. Preferably the gel is encapsulated in a resilient outer envelope.

In preferred embodiments the plug comprises an elastomeric material such as natural or synthetic rubber.

Preferably, the casing comprises at least one open end for feeding the said cable into the interior of the closure, and at least one of the plugs is positioned at the or each open end for closing that end of the closure.

In preferred embodiments the casing comprises at least two casing parts which are capable of being brought together to close the closure. Preferably the casing comprises a pair of half shells which are capable of being brought together along respective opposing edges thereof to close the closure.

In one preferred embodiment the casing is a butt type casing in which only one end of the casing is arranged to receive cables into the interior of the closure. Thus, one or more entry/exit ports may be provided in one end of the butt casing only. In embodiments where multiple entry/exit ports are provided blanking plugs may be used to close entry/exit ports that are not required for a particular installation of the cable splice closure.

Preferably, the casing is provided with fastening means for holding the casing in a closed configuration thereby retaining the plug with respect to the casing substantially in the interior of the closure. In preferred embodiments the fastening means comprise a plurality of threaded fasteners such as screws or bolts which fasten respective halves of the closure casing together when the closure is closed. Tensioning of the fastening means against the resilience of the plug causes the plug and seal to compress.

According to another aspect of the invention there is provided a cable splice closure comprising a casing and at lest one resilient end plug for closing a respective entry/exit port of the casing, the casing being capable of being closed around the said plug to close the closure, the said end plug having at least one opening through which a length of cable or other elongate member is capable of being fed into the interior of the closure, the plug being compressed, in use, by closure of the casing such that the said cable or elongate member is held with respect to the plug by compression forces applied to the plug by the casing. Thus the present invention also contemplates embodiments where the cables are retained substantially entirely by the compression of the resilient plug against the cables where compression of the plug is caused by closure of the casing around the plug.

According to another aspect of the invention there is provided a kit-of-parts for a cable splice as previously described.

According to a further aspect of the invention there is provided a method of installing a cable splice comprising the steps of:

providing a cable splice closure having a casing and at least one resilient end plug for closing a respective end of the casing, the casing being capable of being closed around the said plug to close the closure, the said end plug having at least one opening for receiving a length of cable or other elongate member to be fed into the interior of the closure, and at least one retention means for retaining the said cable or other elongate member with respect to the plug,

positioning one or more lengths of cable to be fed into the interior of the closure in one or more of the said respective openings;

positioning at least one cable retention means around the exterior of the plug to surround the plug and the cable(s);

tightening the cable retention means against the plug and the cable(s) to compress the plug against the cable(s) and retain the cable(s) with respect to the plug; and

closing the casing around the plug to further compress the plug such that the said cable or elongate member is additionally held by compression forces applied to the plug by the said casing.

Various embodiments of the present invention will now be more particularly described, by way of example only, with reference to the accompanying drawings, in which:

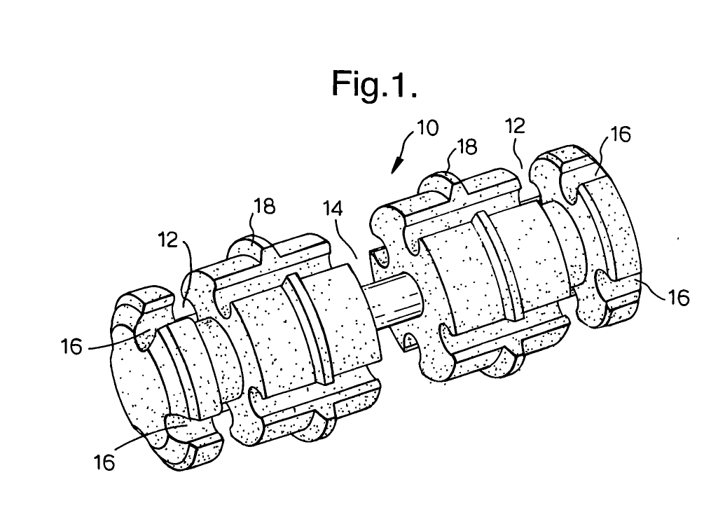

FIG. 1 is a perspective three-dimensional view of a resilient end plug for a cable splice closure;

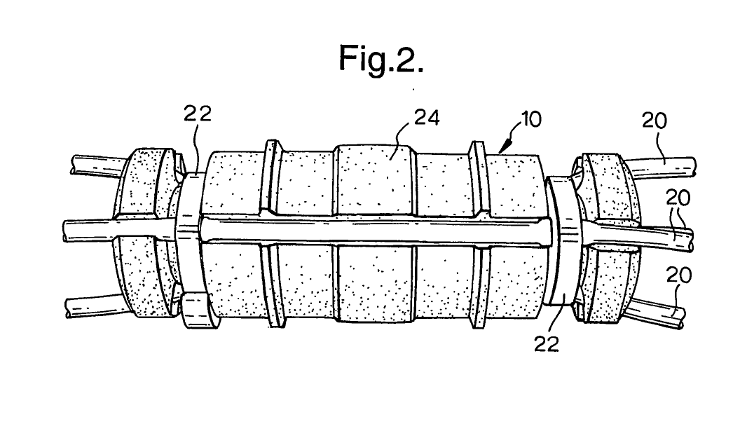

FIG. 2 shows the end plug of FIG. 1 with a plurality of cables secured to the plug;

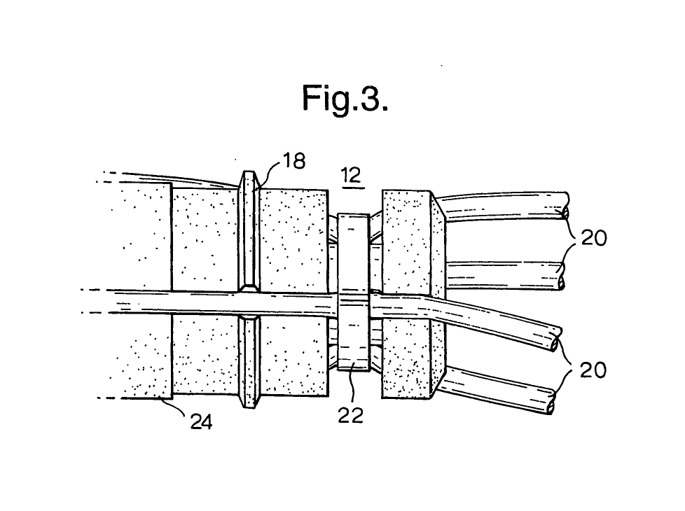

FIG. 3 is a detailed view at one end of the end plug illustrated in FIG. 2;

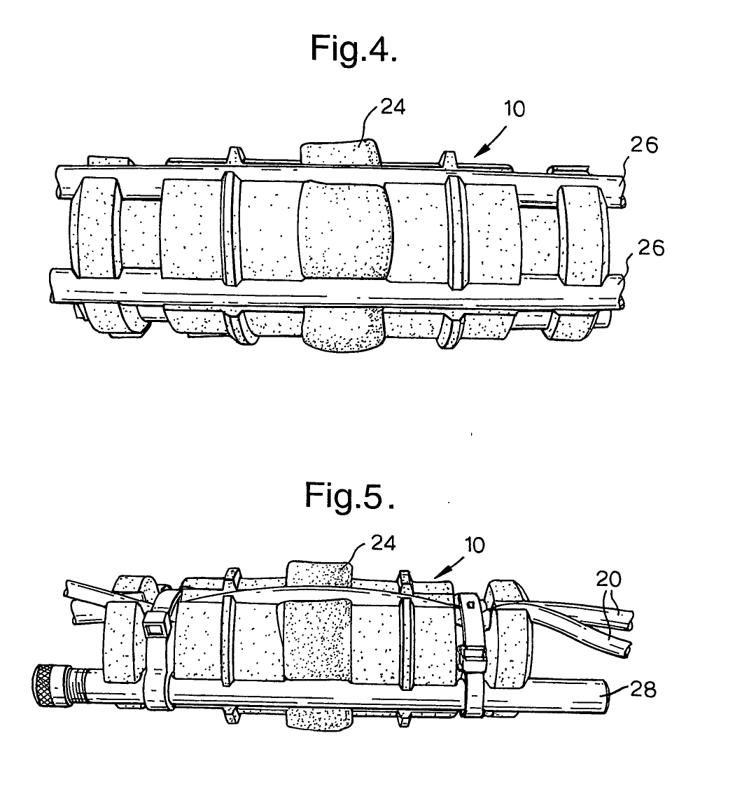

FIG. 4 is a view similar to FIG. 2 but with the cables replaced by blanking tubes;

FIG. 5 is a view similar to FIG. 2 with one of the cables replaced by a tubular valve component;

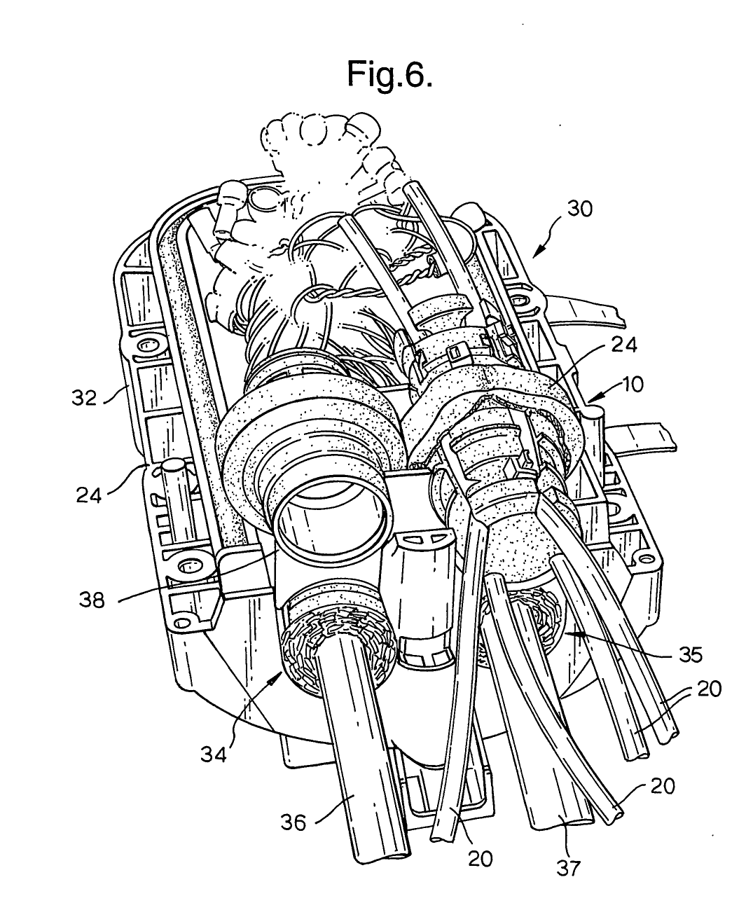

FIG. 6 is a perspective view of a part assembled cable splice closure with part of the casing removed to reveal an end plug and cable similar to that of FIG. 2 mounted in the closure; and,

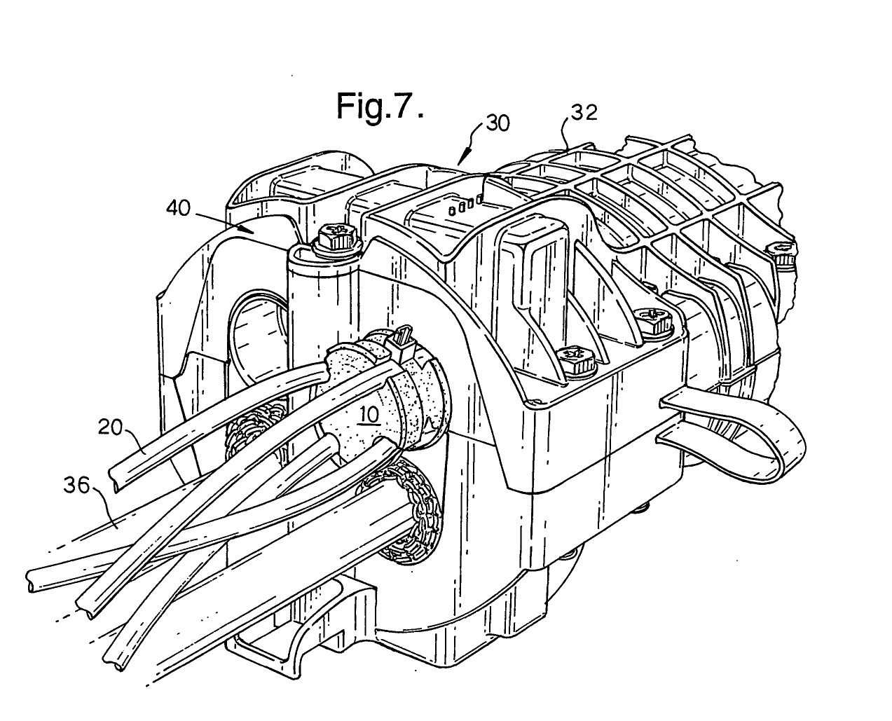

FIG. 7 is a view of the closure of FIG. 6 with the top part of the casing in place.

Referring to FIG. 1, a resilient end plug 10 for closing a respective entry/exit port of a cable splice closure casing is shown. The end plug is of a one-piece unitary construction of a resilient and compressible elastomeric material. The material of the plug is preferably rubber although other suitable resilient materials could be used. The end plug has a generally cylindrical shape having a generally circular cross-section. A pair of circumferential grooves 12 are provided at respective opposite axial ends of the plug. A further circumferential groove 14 is provided in the central part of the plug between the end grooves 12. A plurality of elongate axially extending channels 16 are provided along the exterior of the plug. In the arrangement shown in FIG. 1 for such elongate channels 16 are provided at substantially 90° intervals around the circumference of the plug. The channels 16 have a generally U-shaped cross-section for accommodating cables and/or other elongate members that are to be fed into the interior of a cable splice closure. The radial depth of the channels 16 is determined substantially by the diameter of the cables or other members the channels are to receive. The channels may, for example, have a cross-section suitable for accommodating cables having diameters in the range 3 mm to 7 mm for one particular embodiment.

The radial depth dimension of the end grooves 12 and the central groove 14 are greater than the radial depth of the channels 16 with the central groove 14 having a radial depth greater than the end grooves 12. The axial dimension of the central groove 14 is greater than that of the end grooves 12 and generally twice the axial dimension of the end grooves 12.

The exterior of the plug 10 is provided with a pair of radial flange type protrusions 18 which extend around the circumference of the plug. One of the protrusions 18 is positioned substantially midway between a first of the end grooves 12 and the central groove 14, and the other protrusion is positioned midway between the other of the end grooves 12 and the central groove 14. In this respect it can be seen that the plug is substantially symmetrical about a plane perpendicular to the axis of the plug positioned midway between the respective axial ends of the plug.

As can now be seen with reference to FIG. 2, cables 20 that are to be fed into the interior of a cable splice closure are secured to the plug 10 at two axial locations along their length prior to being assembled into a cable splice closure. The cables 20 are positioned along part of their length in the respective cable channels 16 which extend along the length of the plug. Once the cables have been correctly positioned in the channels the installation engineer secures the cables to the plug by means of cable tie wrap type devices 22 which are wrapped around the cables and the plug at each of the end groove 12 positions. Tightening of the cable wrap ties causes the cables to be pulled, or drawn, radially inwards into the region of the circumferential end recesses 12.

As can best be seen in FIG. 3, the cables are pulled into the end groove 12 by tightening of the cable wrap tie to such an extent that the wrap tie is substantially entirely enclosed within the end groove 12. The respective cables 20 bend into a V or U-shaped section along their length in the respective end grooves 12. The cable wrap ties 22 are of the type which permit tightening but not loosening of the tie in use.

The cables are secured at both axial ends of the plug by respective cable wrap ties 22. In this way the end grooves 12 define cable retention grooves. The central groove 14 contains a gel type seal element 24. The central groove 14 constitutes a seal retention groove. In the example shown the seal 24 has been positioned in the central groove 14 prior to positioning of the cables and securing the cables to the plug. In other embodiments the seal element 24 may be positioned around the groove 14 radially outwards of the cables 20 once they have been secured to the plug, as can be seen in the part assembled drawing of FIG. 6. The sealing element 24 is preferably in the form of a torus which can be fitted into the groove 14 or around the cables as desired.

Referring now to FIG. 4, in installations where not all of the elongate channels 16 are required for cables, cable blank tubes 26 are positioned in the empty channels 16 in order to prevent distortion of the plug by closing of the otherwise empty channels when the plug is compressed in use. It will be understood therefore that the plug of FIG. 1 may be used to feed one, two, three or a maximum of four cables or other elongate members into the interior of the closure. In the arrangement of FIG. 5 one of the cables 20 shown in the arrangement of FIG. 2 has been replaced by a tubular member 28 which constitutes a valve for pressurising the interior of the closure in use.

Referring now to FIG. 6, a cable splice closure 30 is shown with the top part of a two-part casing 32 removed to reveal the interior of the cable splice closure. The closure 30 is of the butt type since cables are only fed from one end of the casing into the interior of the closure.

The end of the closure 30 through which cables and the like are fed into the interior of the closure is provided with four ports arranged in two rows of two ports. The bottom two ports 34 and 35, as shown in the illustration of FIG. 6, accommodate respective telecommunication cables 36 and 37. The top left hand port, as shown in FIG. 6, is fitted with a tubular type blanking plug 38, while the top right hand port accommodates a plug 10 of the type previously described with reference to FIGS. 1 to 5. The plug 10 has four drop cables 20 secured thereto. In this arrangement the gel type seal 24 surrounds the plug 10 and the drop cables 20 so that when the top of the casing is attached to the lower casing part as shown in FIG. 7, the plug 10 and gel type seal 24 are compressed thereby sealing around the cables and sealing between the cables and the casing parts. Effective sealing of the interior of the closure depends primarily on the forces exerted on the plug 10 and the gel type seal 24 by the casing parts when they are brought together and fastened with respect to each other by threaded type fastening bolts 40 provided around the casing, as shown in the closed arrangement of FIG. 7.

In the closure shown in FIGS. 6 and 7 the blanking part 38 is also provided with a toroidal gel type seal 24 to ensure correct sealing of the blanking part 38 with respect to the casing. As the cables 36 and 37 in the lower ports 34 and 35 are more permanent the cables 36 and 37 are sealed with respect to the casing using more appropriate permanent type seals. Such seals are well known to the skilled person. It will be understood therefore that the cable splice closure of the present invention is particularly suitable for network installations where it is necessary to be able to re-enter the closure and reconfigure the wiring connections in the interior of the closure.

As can be seen in the illustration of FIG. 7, one end of the plug 10 protrudes from the casing so that the cable wrap tie 22 at that end of the plug is accessible on the exterior of the casing.

Although aspects of this invention have been described with reference to the embodiments shown in the accompanying drawings, it is to be understood that the invention is not limited to those precise embodiments and that various changes and modifications may be effected without further effective skill and effort. For example, the closure casing may be a one-piece integral structure such as a flexible and resilient tubular element that is split along each length so that it may be wrapped around a cable splice to enclose a cable splice. The one piece casing may be of a resilient elastomeric material such as rubber with fastening means such as over the centre type latches provided along the split of the casing to ensure the casing applies the necessary compressive loads to the plug and gel type seal.

1. A cable splice closure comprising a casing and at least one resilient end plug for closing a respective entry/exit port of the casing, the casing being capable of being closed around the said plug to close the closure, the said end plug having at least one opening through which a length of cable or other elongate member is capable of being fed into the interior of the closure, and at least one retention means for retaining the said cable or other elongate member with respect to the plug, the plug being compressed, in use, by closure of the casing such that the said cable or elongate member is held with respect to the plug by compression forces applied to the plug by the said casing.

2. A closure as claimed in claim 1 wherein the said cable retention means is capable of being wrapped around the exterior of the plug to surround the plug and the said cable so that tightening of the retention means draws the said cable and plug together and compresses the plug against the cable.

3. A closure as claimed in claim 3 wherein the retention means comprises a cable tie or wrap tie.

4. A closure as claimed in any preceding claim wherein the plug is generally cylindrical.

5. A closure as claimed in claim 5 wherein the said cylinder has a generally circular cross-section.

6. A closure as claimed in any preceding claim wherein the said opening extends in the longitudinal direction of the plug to provide at least one open channel on the exterior of the plug for receiving the said cable or other elongate member.

7. A closure as claimed in claim 6 wherein the plug comprises a plurality of channels circumferentially spaced about the exterior of the plug.

8. A closure as claimed in claim 7 wherein different channels are sized to accommodate different size cables.

9. A closure as claimed in any preceding claim wherein the plug comprises at least one circumferential cable retention groove for receiving a length or lengths of cable deflected radially inwards into the said groove, in use, by tightening of a respective cable retention means surrounding the exterior of the plug and the said cable in the region of the said groove.

10. A closure as claimed in claim 9 wherein the said groove has a depth in the radial direction greater than the radial depth of the said opening.

11. A closure as claimed in claim 9 or 10 wherein the depth of the said groove in the radial direction is sufficient to accommodate the said deflected cable and the said cable retention means acting on the said cable around the said groove.

12. A closure as claimed in any of claims 9 to 11 comprising at least two said circumferential grooves axially spaced along the length of the plug, each groove being provided for accommodating a respective retention means.

13. A closure as claimed in claim 12 comprising a pair of said circumferential grooves positioned at opposite axial ends of the said plug.

14. A closure as claimed in any of claims 9 to 13 further comprising at least one further circumferential groove having a compressible seal located therein for compression of the seal against the plug and the said cable to hold the seal against the plug and the said cable so as to seal the closure and further retain the said cable with respect to the closure by force(s) applied by the casing to the seal and the plug when the casing is closed.

15. A closure as claimed in claim 14 wherein the said further groove is axially located between first and second cable retention grooves.

16. A closure as claimed in claim 14 or claim 15 wherein the said further groove has a depth in the radial direction greater than the radial depth of the said cable retention grooves.

17. A closure as claimed in any of claims 14 to 16 wherein the seal comprises a gel type material.

18. A closure as claimed in claim 17 wherein the gel is encapsulated in a resilient outer envelope.

19. A closure as claimed in any preceding claim wherein the plug comprises an elastomeric material.

20. A cable splice closure as claimed in any preceding claim wherein the casing comprises at least one open end for feeding the said cable into the interior of the closure, and at least one of the said plugs is positioned at the or each open end for closing that end of the closure.

21. A closure as claimed in any preceding claim wherein the casing comprises at least two casing parts which are capable of being brought together to close the closure.

22. A closure as claimed in any preceding claim wherein the casing comprises a pair of half shells which are capable of being brought together along respective opposing edges thereof to close the closure.

23. A closure as claimed in any of any preceding claim wherein the casing is a butt type casing in which only one end of the casing is arranged to receive cable(s) into the interior of the closure.

24. A closure as claimed in any preceding claim wherein the said casing is provided with fastening means for holding the casing in a closed configuration thereby retaining the said plug with respect to the casing substantially in the interior of the closure.

25. A cable splice closure comprising a casing and at least one resilient end plug for closing a respective entry/exit port of the casing, the casing being capable of being closed around the said plug to close the closure, the said end plug having at least one opening through which a length of cable or other elongate member is capable of being fed into the interior of the closure, the plug being compressed, in use, by closure of the casing such that the said cable or elongate member is held with respect to the plug by compression forces applied to the plug by the said casing.

26. A kit of parts for providing a cable splice closure according to any preceding claim.

27. A method of installing a cable splice comprising the steps of:
a) providing a cable splice closure having a casing and at least one resilient end plug for closing a respective end of the casing, the casing being capable of being closed around the said plug to close the closure, the said end plug having at least one opening for receiving a length of cable or other elongate member to be fed into the interior of the closure, and at least one retention means for retaining the said cable or other elongate member with respect to the plug;
b) positioning one or more lengths of cable to be fed into the interior of the closure in one or more of the said respective openings;
c) positioning at least one cable retention means around the exterior of the plug to surround the plug and the cable(s);
d) tightening the cable retention means against the plug and the cable(s) to compress the plug against the cable(s) and retain the cable(s) with respect to the plug;
e) closing the casing around the plug to further compress the plug such that the said cable or elongate member is additionally held by compression forces applied to the plug by the said casing.

28. A cable splice closure substantially as hereinbefore described and/or as illustrated in the accompanying drawings.

29. A kit of parts for a cable splice closure substantially as hereinbefore described and/or as illustrated in the accompanying drawings.

30. A method of installing a cable splice substantially as hereinbefore described and/or as illustrated in the accompanying drawings.
